(19) United States
(12) Patent Application Publication
(10) Pub. No.: US 2006/0216431 A1
(43) Pub. Date: Sep. 28, 2006

(54) Electrostatic abluminal coating of a stent crimped on a balloon catheter

(76) Inventor: Cameron K. Kerrigan, Burlingame, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 11/093,166

(22) Filed: Mar. 28, 2005

(51) Int. Cl. B05D 1/04

(52) U.S. Cl. 427/458

(57) ABSTRACT

A method for an electrostatic abluminal coating of a stent crimped on a balloon catheter is disclosed. In one form of the method, a stent-balloon assembly is formed by crimping or otherwise mounting a stent on the balloon of a catheter. A conductive wire is thereafter threaded through the lumen of the stent-balloon assembly and a charge is applied thereto. The stent may be grounded or, alternatively, be potentiated with a charge opposite to that of the conductive wire. An electrostatic spray with the same charge as that of the conductive wire may then be applied to the stent-balloon assembly. In this manner, a stent-balloon assembly which is coated on the abluminal surface but substantially or completely free of coating on the luminal surface and the outside surface of the exposed portions of the balloon is realized.

### BACKGROUND OF THE INVENTION

Stents are often modified today to provide drug delivery capabilities by coating them with a polymeric carrier impregnated with a drug or therapeutic substance. A conventional method of coating includes applying a composition including a solvent, a polymer dissolved in the solvent, and a therapeutic substance dispersed in the blend to the stent by immersing the stent in the composition or by spraying the composition onto the stent. The solvent is allowed to evaporate, leaving on the stent strut surfaces a coating of the polymer and the therapeutic substance impregnated in the polymer. The dipping or spraying of the composition onto the stent can result in a coating of all stent surfaces, that is, both luminal (inner) and abluminal (outer) surfaces.

Having a coating on the luminal surface of the stent can detrimentally impact the stent's deliverability as well as the coating's mechanical integrity. Moreover, from a therapeutic standpoint, the therapeutic agents on an inner surface of the stent are washed away by the blood flow and typically can provide for an insignificant therapeutic effect in addition to being a wasteful application of the same. In contrast, the agents on the outer surfaces of the stent contact the lumen of an occluded vessel and provide for the delivery of the agent directly to the tissues. Polymers of a stent coating also elicit a response from the body. Reducing the amount to foreign material, such as residual luminal coating of a coated stent, can only be beneficial.

In a typical medical application of a stent, an inflatable balloon of a catheter assembly is inserted into a hollow bore of a coated stent. The stent is securely mounted on the balloon by a crimping process. The balloon is inflated to implant the stent, deflated, and then withdrawn out from the bore of the stent. A polymeric coating on the inner surface of the stent can increase the coefficient of friction between the stent and the balloon of a catheter assembly on which the stent is crimped for delivery. Additionally, some polymers have a “sticky” or “tacky” consistency. If the polymeric material either increases the coefficient of friction or adheres to the catheter balloon, the effective release of the stent from the balloon after deflation can be compromised. Additionally, if the stent coating adheres to the balloon, the coating, or parts thereof, can be pulled off the stent during the deflation and withdrawal of the balloon following the placement of the stent. Adhesive, polymeric stent coatings can also experience extensive balloon sheer damage post-deployment, which can result in a thrombogenic stent surface and possible embolic debris. Further, the stent coating can stretch when the balloon is expanded and may delaminate as a result of such shear stress.

Post-crimping coating processes have been proposed for elimination of the coating on the inner surface of the stent. Briefly, subsequent to the mounting of the stent on the balloon, the stent can be dipped in the coating composition or the composition can be sprayed on the stent. Even though application of coating on the inner surface of the stent is eliminated, the coating is also deposited on the surface of the balloon between the stent struts. With this type of coating, the problems of adhesion of the stent to the balloon and formation of coating defects upon expansion, deflation and withdrawal of the balloon are not eliminated, and in effect, such problems can be further increased.

Coating of the stent prior to mounting of the stent on the balloon can also damage the coating on the outer surface of the stent. Stent crimping tools can cause coating defects on the stent by applying too much pressure at various directions to a soft polymeric coating. Harder or brittle polymers can have coating failure or crack under crimping pressure. However, stent crimping is important for stent retention.

Stent crimping is the act of affixing the stent to the delivery catheter or delivery balloon so that it remains affixed thereto until the physician desires to deliver the stent at the treatment site. Current stent crimping technology is sophisticated. A short time ago, one crimping process used a roll crimper. This damaged many polymer coatings due to its inherent shearing action. Next came the collet crimper using metal jaws that are mounted into what is essentially a drill chuck, whereby the jaws move in a purely radial direction. This movement was not expected to shear the coating, because it applied forces only normal to the stent surface. But some stent geometries require that stent struts scissor together during crimping. In those geometries, even if the crimper imposes only normal forces, the scissor action of the stent struts imparts shear forces. Finally, the iris or sliding-wedge crimper imparts mostly normal forces with some amount of tangential shear.

To use a roll crimper, the stent is first slid loosely onto the balloon portion of the catheter. This assembly is placed between the plates of the roll crimper. With an automated roll crimper, the plates come together and apply a specified amount of force. They then move back and forth a set distance in a direction perpendicular to the catheter. The catheter rolls back and forth under this motion, and the diameter of the stent is thereby reduced. The process can be broken down into more than one step, each with its own level of force, translational distance, and number of cycles. With regard to a stent with a drug delivery coating, this process imparts considerable shear to the stent in a direction perpendicular to the catheter or catheter wall. Furthermore, as the stent is crimped, there is additional relative motion between the stent surface and the crimping plates. Consequently, this crimping process tends to damage the stent coating.

The collet crimper is equally conceptually simple. A standard drill-chuck collet is equipped with several pie-piece-shaped jaws. These jaws move in a radial direction as an outer ring is turned. To use this crimper, a stent is loosely placed onto the balloon portion of a catheter and inserted in the center space between the jaws. Turning the outer ring causes the jaws to move inward. An issue with this device is determining or designing the crimping endpoint. One scheme is to engineer the jaws so that when they completely close, they thereby touch and a center hole of a known diameter remains. Using this approach, turning the collet onto the collet stops crimps the stent to the known outer diameter. This technique can lead to problems. Stent struts have a tolerance on their thickness. Additionally, the process of folding non-compliant balloons is not exactly reproducible. Consequently, the collet crimper exerts a different amount of force on each stent in order to achieve the same final dimension. Unless this force and the final crimped diameter are carefully chosen, the variability of the stent and balloon dimensions can yield stent coating or balloon damage.

Furthermore, although the collet jaws move in a radial direction, they move closer together as they crimp. This action, combined with the scissoring motion of the struts, imparts tangential shear on the coatings that can also lead to damage. Lastly, the actual contact surfaces of the collet crimper are the jaw tips. These surfaces are quite small, and only form a cylindrical surface at the final point of crimping. Before that point, the load being applied to the stent surface is discontinuous.

In the sliding wedge or iris crimper, adjacent pie-piece-shaped sections move inward and twist, similar to the leaves in a camera aperture. This crimper can be engineered to have two different types of endpoints; namely, it can stop at a final diameter or it can apply a fixed force and allow the final diameter to float. From the discussion on the collet crimper, there are advantages in applying a fixed level of force as variabilities in strut and balloon dimension will not change the crimping force. The sliding wedges impart primarily normal forces, which are the least damaging to stent coatings. As the wedges slide over each other, they impart some tangential force. But the shear damage is frequently equal to or less than that of the collet crimper. Lastly, the sliding wedge crimper presents a nearly cylindrical inner surface to the stent, even as it crimps. This means the crimping loads are distributed over the entire outer surface of the stent.

Current stent crimping methods were developed for all-metal stents. Stent metals, such as stainless steel, are durable and can take abuse. When crimping was too severe, it usually damaged the underlying balloon, not the stent. But polymeric coatings present different challenges.

### SUMMARY OF THE INVENTION

Accordingly, a method for coating the abluminal surfaces of a stent, which is crimp-mounted on a balloon catheter, with the luminal surfaces of the stent free from coating and resistant to physical disruption post-coating is disclosed herein. In other words, a method of manufacturing a coated stent-balloon assembly wherein the abluminal surfaces of the stent are completely or substantially coated and the luminal surfaces of the stent and the outer surface of the balloon are free or substantially free of coating is provided.

In one form of this method, a stent is positioned (and preferably crimped) on a balloon of a catheter assembly forming a stent-balloon assembly. The stent may or may not have a coating, and preferably does not have a coating. A wire may then be threaded through a lumen of the stent-balloon assembly. The wire can be the guidewire for the catheter and can be threaded through the guidewire lumen. A charge may then be applied to the guidewire, while the stent is grounded. Alternatively, a charge may be applied to the stent that is opposite to the charge applied to the guidewire. Once the guidewire is charged and the stent is grounded and/or oppositely charged, an electrostatic spray coating is applied to the stent-balloon assembly. The charge of the electrostatic spray may be the same as the charge applied to the guidewire.

A coated stent-balloon assembly formed by one form of the present method is also provided. The stent-balloon assembly includes a stent having an abluminal surface and a luminal surface, wherein the abluminal surface is completely or substantially coated by an electrostatically applied coating; and a balloon having an outside surface and an inside surface, wherein the outside surface is substantially adjacent to the luminal surface of the stent, and wherein the stent is crimped on the balloon before the electrostatic coating is applied.

Other objects and advantages of the present invention will become more apparent to those. persons having ordinary skill in the art to which the present invention pertains from the foregoing description taken in conjunction with the accompanying drawings.

### BRIEF DESCRIPTION OF THE DRAWINGS

FIG. 1 is a perspective view of one embodiment of a catheter-balloon assembly showing a stent being positioned thereon;

FIG. 2 is a partial side view of the assembly of FIG. 1 with the stent mounted and being crimped thereon, forming a stent-balloon assembly;

FIG. 3 is a side view of the stent-balloon assembly of FIG. 2, a guidewire threaded through the stent-balloon guidewire lumen and an electrostatic spray charge applied thereto according to one embodiment of the present invention; and

FIGS. 4A-4D are cross-sectional views illustrating one embodiment of a series of steps of electrostatic spray coating of a stent-balloon assembly pursuant to the present invention, wherein the coating is realized on the surface of the stent only; and

FIGS. 5A-5B are cross-sectional views illustrating an embodiment of the present invention in which the coating is realized on both the sidewalls and surface of the stent.

### DETAILED DESCRIPTION OF PREFERRED EMBODIMENTS OF THE INVENTION

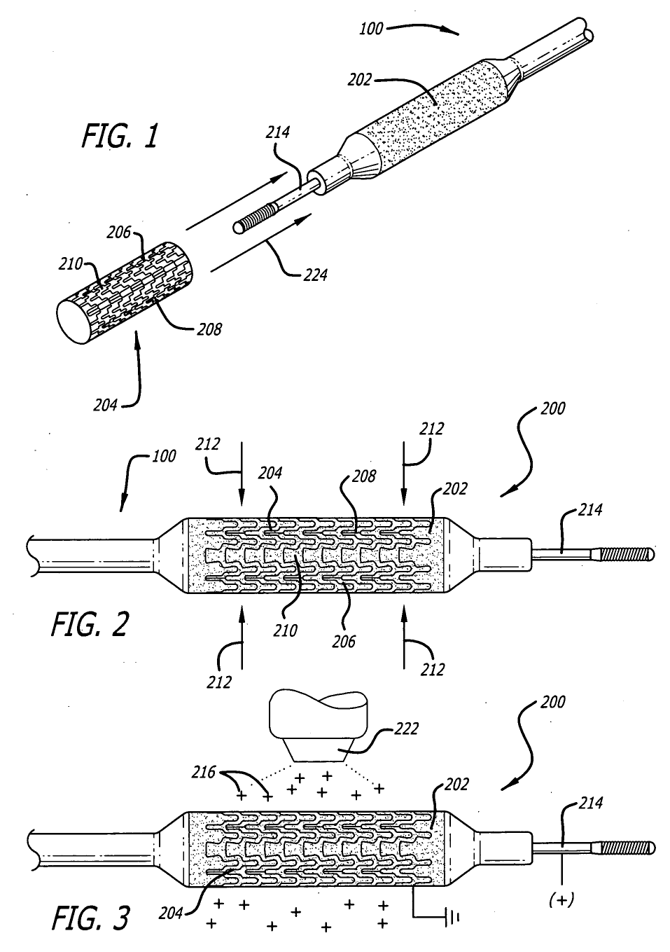

FIGS. 1-3 generally illustrate a method for manufacturing a coated stent-balloon assembly using electrostatic spray coating methods wherein the luminal surfaces of the stent and the outer surface of the balloon are completely or substantially free of coating.

In FIG. 1, a catheter 100 with a balloon 202 mounted thereto is illustrated with a stent 204 shown in an unmounted relationship to the catheter 100. For an example of a catheter, see U.S. Pat. No. 4,988,356 to Crittenden et al. As illustrated, the stent 204 may have a scaffolding network which includes struts 206 connected by elements 208 such that gaps 210 are formed therebetween, as is known in the art. The stent 204 may be made from a metallic material, a polymeric material, such as those that are bioabsorbable, degradable, or erodable in kind, or a combination of both metallic material and polymers. The balloon 202 is an expandable member which is bio-friendly to biological tissues typically used in vessel application. Moreover, the stent 204 may be expandable or self-expandable.

In FIG. 2, a side view of the catheter of FIG. 1 is illustrated with the balloon 202 and the stent 204 mounted thereto, forming a balloon-stent assembly 200. FIG. 2 illustrates generally a series of steps of one form of the method of the present invention, or the mounting of the stent 204 on the balloon 202. After the mounting, the outer surface of the balloon 204 is partially exposed via the gaps 210 of the stent 204. Subsequent to positioning of the stent 204 on the balloon 202, the stent is crimped onto the balloon 202, as illustrated by arrows 212. Crimping may be performed by those methods and devices more fully described in the Background of the Invention portion of this disclosure. See also, U.S. Pat. No. 6,277,110 to Morales. A stent press can be used to further compress the stent to provide firmer engagement with the balloon 202 (for example, using FFS700 MSI Balloon Form/Fold/Set Equipment, available from Machine Solutions, Inc.). Thereafter, a guidewire 214 is passed through a lumen of the stent-balloon assembly 200 which lumen may be, for example, the guidewire lumen. The guidewire is intended to be the wire used during the procedures over which the catheter is threaded. Alternatively, a conductive wire may be threaded through a lumen of the stent-balloon assembly 200. The lumen should preferably be the lumen that is positioned at a center position with respect to the balloon 202 when the balloon is in a deflated state. Advantageously, the guidewire or other form of a conductive material can create a conductive field uniformly applied around the balloon 202. The conductive wire may be of a material which has a higher conductivity capacity than that of the guidewire 214, thereby increasing the potential of the electrically charged environment inside of the lumen of the stent-balloon assembly 200. In some embodiments, a guidewire 214 may be included in the assembly prior to initiation of the crimping process.

A series of subsequent steps in one form of the method of the present invention is illustrated generally by FIG. 3. In some embodiments, a first charge or potential with the same polarity of the coating substance (e.g., positive) is applied to the guidewire 214 (or alternatively the conductive wire). Alternatively, or in addition to application of a potential to the guidewire 214, the stent 204 can be grounded. It is anticipated that the charge applied to the guidewire 214 will create a charged environment within the lumen of the stent-balloon assembly 200 and about the surface of the balloon 202. In some embodiments, a potential opposite to that of the coating substance (e.g., negative charge) can be applied to the stent 204 instead of grounding of the stent 204. The application of the potential to the stent 204 can be separate or in conjunction with the application of a charge to the guidewire 214. Next a charged coating substance (e.g., positive charge as illustrated), such as by electrostatic deposition process, as is well known to one having ordinary skill in the art, is applied to the stent-balloon assembly 200, such as out of nozzle 222.

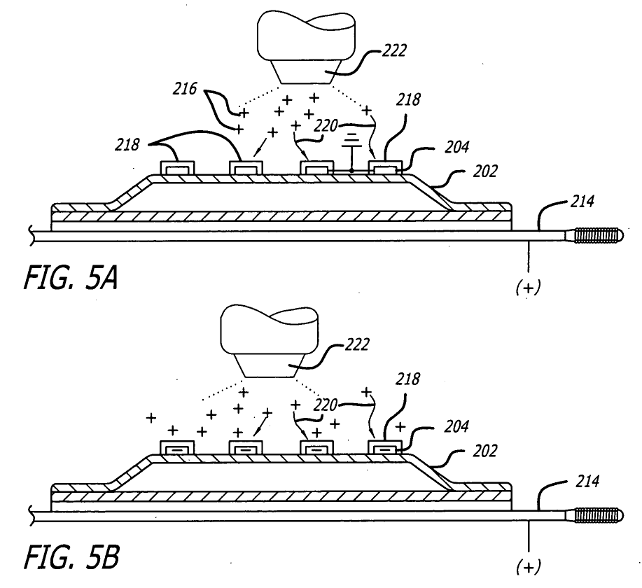

In some embodiments, the charge of the spray will be the same as the charge applied to the guidewire 214. In this manner, the positively charged particles 216 are attracted to the abluminal surfaces of the stent 204, while simultaneously repelled by the positively charged environment of the lumen of the stent-balloon assembly 200 effectuated by the positively charged guidewire 214. As a result, a stent-balloon assembly 200 with an abluminal coating on the stent is formed with the luminal surface of the stent 204 and the partially-exposed outer surface of the balloon 202 substantially or completely free of coating. The voltage of the various electrical charges may be adjusted to effectuate maximum abluminal surface coverage of the stent 204 and minimal to no coverage of the luminal surface of the sent 204 and the outer surface of the balloon 202. The sidewalls of the stent 204 may or may not be coated (see FIGS. 5A-5B).

In conventional electrostatic spraying, a spray formulation is electrically charged. The object to which the spray is applied may be then grounded or potentiated with a charge opposite to that of the spray. For example, electrostatic spraying of a medical device may involve a potentiated therapeutic coating sprayed on a grounded or oppositely charged stent. When the electrically charged spray is applied, the particles of the spray will therefore be attracted to the grounded or oppositely charged stent. As the spraying continues, new spray particles will be deflected by the charged coated regions of the stent, thereby deflecting the new spray particles to uncoated regions of the stent. In this manner, the stent device is substantially uniformly coated.

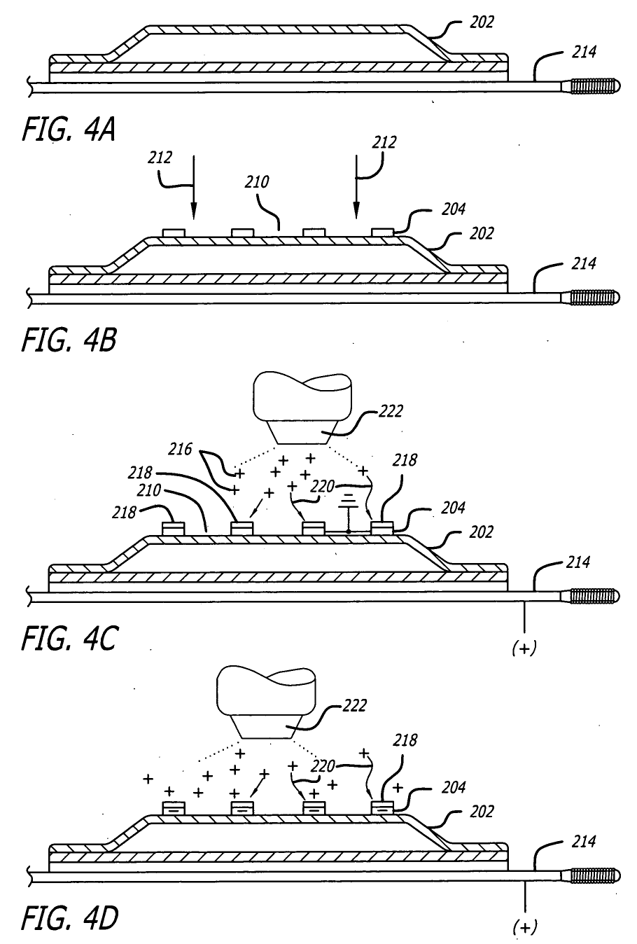

In FIGS. 4A-4D, cross-sectional views of one form of the method of the present invention are illustrated. In FIG. 4A, a cross-section of the balloon 202 is shown integrated with the catheter 100 (not shown in these figures). In FIG. 4B, a cross-section of the stent 204 is shown mounted on the balloon 202, forming the stent-balloon assembly 200 wherein the outer surface of the balloon is partially exposed in the areas of the gaps 210 of the stent. The stent 204 can then be crimped onto the balloon 202, illustrated by crimping arrows 212. The guidewire 214 is also shown in FIG. 4A threaded through a lumen of the stent-balloon assembly 200. The lumen is strategically the center most lumen of the device. Alternatively other forms of conductive wires or materials can be used instead of the guidewire 214.

Following the crimping process, FIG. 4C shows the application of the positively charged particles 216 of an electrostatic spray coating as applied to the stent-balloon assembly 200, illustrated by arrows 220. In this illustration, the stent 204 is grounded. Because the particles 216 are positively charged and because it is anticipated that the positively charged guidewire 214 creates a positive environment in the lumen of the stent-balloon assembly 200, the particles are completely or substantially prevented from adhering to the partially exposed outer surface of the balloon 202. As a result, a coating 218 covers the abluminal surface of the stent 204, while the partially exposed surface of the balloon 202 and the inner surface of the stent 204 advantageously remain free or substantially free of coating 218. The inner surface of the stent 204 remains free or substantially free of coating 214 as it is masked by the fitting engagement to the balloon 202 from the crimping process. The sidewalls of the stent 204 may or may not be coated (see FIG. 5A).

FIG. 4D shows an alternative form of the method step of FIG. 4C. As in FIG. 4C, the particles 216 and the guidewire 214 are positively charged. However, in this figure, a negative charge is applied to the stent 204, causing the positively charged particles 216 to adhere to its abluminal surface while the electrostatic spray is being applied to the assembly 200. At the same time, the partially exposed outer surfaces of the balloon 202 substantially repel the particles 216 due to the positively charged guidewire 214 residing in the stent-balloon assembly 200 lumen such that the partially exposed outer surface of the balloon 202 remains substantially or completely free of coating 218. The sidewalls of the stent 204 may or may not coated, as well (see FIG. 5B). It should be understood by those skilled in the art that the various charges applied in the form of the method explained may be reversed to achieve the same abluminal coating effect. In other words, the positive and negative charges for any of the embodiments can be reversed. Further, the electrostatic technique can be modified as would be apparent to those skilled in the art in view of the subject disclosure taken in conjunction with U.S. Pat. No. 6,743,463 to Weber et al. Additionally, more than one nozzle can be used and/or there can be relative rotation of the stent or the nozzle during spraying.

In some embodiments, the stent 204 can be first grounded, and, during the application of the coating substance, a negative charge can be applied to the stent 204. In some embodiments, the negative charge can be applied slowly, incrementally or in a step-wise fashion until the targeted level is reached. If the stent 204 includes a coating, a layer of coating in accordance with the present invention can alleviate damages caused by the crimping process. In some embodiments, the stent 204 can be free from coating as crimped on the balloon or can include a coating (e.g., polymer and/or therapeutic drug coating).

The stent coating material can include one or a combination of a polymer (or polymers) or a therapeutic agent (or agents), with or without a fluid carrier or a solvent. The stent coating 218 can include layer(s) of pure polymer(s) or layer(s) of pure agent(s) or drug(s). The coating can include multiple layers such a primer layer, a drug-reservoir layer, and a topcoat layer.

Examples of polymers that can be used include, but are not limited to, ethylene vinyl alcohol copolymer; polybutylmethacrylate; polymethylmethacrylate; poly(ethylene-co-vinyl alcohol); poly(vinylidene fluoride-co-hexafluororpropene); poly(hydroxyvalerate); poly(L-lactic acid); polycaprolactone; poly(lactide-co-glycolide); poly(hydroxybutyrate); poly(hydroxybutyrate-co-valerate); polydioxanone; polyorthoester; polyanhydride; poly(glycolic acid); poly(D,L-lactic acid); poly(glycolic acid-co-trimethylene carbonate); polyphosphoester; polyphosphoester urethane; poly(amino acids); cyanoacrylates; poly(trimethylene carbonate); poly(iminocarbonate); copoly(ether-esters) (e.g., PEO/PLA); polyalkylene oxalates; polyphosphazenes; biomolecules, such as fibrin, fibrinogen, cellulose, starch, collagen and hyaluronic acid; polyurethanes; silicones; polyesters; polyolefins; polyisobutylene and ethylene-alphaolefin copolymers; acrylic polymers and copolymers; vinyl halide polymers and copolymers, such as polyvinyl chloride; polyvinyl ethers, such as polyvinyl methyl ether; polyvinylidene halides, such as polyvinylidene fluoride and polyvinylidene chloride; polyacrylonitrile; polyvinyl ketones; polyvinyl aromatics, such as polystyrene; polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; polyamides, such as Nylon 66 and polycaprolactam; alkyd resins; polycarbonates; polyoxymethylenes; polyimides; polyethers; epoxy resins; polyurethanes; rayon; rayon-triacetate; cellulose acetate; cellulose butyrate; cellulose acetate butyrate; cellophane; cellulose nitrate; cellulose propionate; cellulose ethers; and carboxymethyl cellulose. KRATON G-1650 can also be used. KRATON is manufactured by Shell Chemicals Co. of Houston, Tex., and is a three block copolymer with hard polystyrene end blocks and a thermoplastic elastomeric poly(ethylene-butylene) soft middle block. KRATON G-1650 contains about 30 mass % of polystyrene blocks.

Therapeutic or bioactive agents can include any agent which is therapeutic, prophylactic, diagnostic, and/or ameliorative. These agents can have anti-proliferative or anti-inflammmatory properties or can have other properties such as antineoplastic, antiplatelet, anti-coagulant, anti-fibrin, antithrombonic, antimitotic, antibiotic, antiallergic, antioxidant as well as cystostatic agents. Examples of suitable therapeutic and prophylactic agents include synthetic inorganic and organic compounds, proteins and peptides, polysaccharides and other sugars, lipids, and DNA and RNA nucleic acid sequences having therapeutic, prophylactic or diagnostic activities. Nucleic acid sequences include genes, antisense molecules which bind to complementary DNA to inhibit transcription, and ribozymes. Some other examples of other bioactive agents include antibodies, receptor ligands, enzymes, adhesion peptides, blood clotting factors, inhibitors or clot dissolving agents such as streptokinase and tissue plasminogen activator, antigens for immunization, hormones and growth factors, oligonucleotides such as antisense oligonucleotides and ribozymes and retroviral vectors for use in gene therapy. Examples of anti-proliferative agents include rapamycin and its functional or structural derivatives, 40-O-(2-hydroxy)ethyl-rapamycin (everolimus), and its functional or structural derivatives, paclitaxel and its functional and structural derivatives. Examples of rapamycin derivatives include 40-epi-(N1-tetrazolyl)-rapamycin (ABT-578), 40-O-(3-hydroxy)propyl-rapamycin, 40-O-[2-(2-hydroxy)ethoxy]ethyl-rapamycin, and 40-O-tetrazole-rapamycin. Examples of paclitaxel derivatives include docetaxel. Examples of antineoplastics and/or antimitotics include methotrexate, azathioprine, vincristine, vinblastine, fluorouracil, doxorubicin hydrochloride (e.g. Adriamycine from Pharmacia & Upjohn, Peapack N.J.), and mitomycin (e.g. Mutamycin® from Bristol-Myers Squibb Co., Stamford, Conn.). Examples of antiplatelets, anticoagulants, antifibrin, and antithrombins include sodium heparin, low molecular weight heparins, heparinoids, hirudin, argatroban, forskolin, vapiprost, prostacyclin and prostacyclin analogues, dextran, D-phe-pro-arg-chloromethylketone (synthetic antithrombin), dipyridamole, glycoprotein IIb/IIIa platelet membrane receptor antagonist antibody, recombinant hirudin, thrombin inhibitors such as Angiomax ä (Biogen, Inc., Cambridge, Mass.), calcium channel blockers (such as nifedipine), colchicine, fibroblast growth factor (FGF) antagonists, fish oil (omega 3-fatty acid), histamine antagonists, lovastatin (an inhibitor of HMG-COA reductase, a cholesterol lowering drug, brand name Mevacor® from Merck & Co., Inc., Whitehouse Station, N.J.), monoclonal antibodies (such as those specific for Platelet-Derived Growth Factor (PDGF) receptors), nitroprusside, phosphodiesterase inhibitors, prostaglandin inhibitors, suramin, serotonin blockers, steroids, thioprotease inhibitors, triazolopyrimidine (a PDGF antagonist), nitric oxide or nitric oxide donors, super oxide dismutases, super oxide dismutase mimetic, 4-amino-2,2,6,6-tetramethylpiperidine-1-oxyl (4-amino-TEMPO), estradiol, anticancer agents, dietary supplements such as various vitamins, and a combination thereof. Examples of anti-inflammatory agents including steroidal and non-steroidal anti-inflammatory agents include tacrolimus, dexamethasone, clobetasol, combinations thereof. Examples of cytostatic substance include angiopeptin, angiotensin converting enzyme inhibitors such as captopril (e.g. Capoten® and Capozide X from Bristol-Myers Squibb Co., Stamford, Conn.), cilazapril or lisinopril (e.g. Prinivil® and Prinzide® from Merck & Co., Inc., Whitehouse Station, N.J.). An example of an antiallergic agent is permirolast potassium. Other therapeutic substances or agents which may be appropriate include alpha-interferon, bioactive RGD, and genetically engineered epithelial cells. The foregoing substances can also be used in the form of prodrugs or co-drugs thereof. The foregoing substances are listed by way of example and are not meant to be limiting. Other active agents which are currently available or that may be developed in the future are equally applicable.

Representative examples of solvents that can be combined with the polymer and/or active agent include chloroform, acetone, water (buffered saline), dimethylsulfoxide, propylene glycol methyl ether, iso-propylalcohol, n-propylalcohol, methanol, ethanol, tetrahydrofuran, dimethylformamide, dimethylacetamide, benzene, toluene, xylene, hexane, cyclohexane, pentane, heptane, octane, nonane, decane, decalin, ethyl acetate, butyl acetate, isobutyl acetate, isopropyl acetate, butanol, diacetone alcohol, benzyl alcohol, 2-butanone, cyclohexanone, dioxane, methylene chloride, carbon tetrachloride, tetrachloroethylene, tetrachloro ethane, chlorobenzene, 1,1,1-trichloroethane, formamide, hexafluoroisopropanol, 1,1,1-trifluoroethanol, and hexamethyl phosphoramide, and a combination thereof.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thereof.

What is claimed is:

1. A method of manufacturing a coated stent-balloon assembly, comprising:
mounting a stent on a balloon of a catheter assembly to form a stent-balloon assembly; and
after the mounting of the stent, applying charged particles of a coating substance to the stent so as to form a coating on the stent.

2. The method of claim 1, wherein the mounting of the stent comprises positioning of the stent over the balloon and crimping of the stent to the balloon.

3. The method of claim 1, additionally comprising (a) applying a potential to the stent, the potential having an opposite polarity as the polarity of the charged particles or (b) grounding the stent.

4. The method of claim 1, wherein the assembly additionally comprises a wire disposed in a lumen of the catheter, and wherein the method additionally comprises applying a potential to the wire, the potential having the same polarity as the charged particles.

5. The method of claim 4, wherein the potential is of sufficient magnitude so as to prevent deposition of the coating substance on a surface of the balloon in gapped regions between stent struts or so as to minimize the amount of coating substance being applied to the surface of the balloon as compared to if a potential is not applied to the wire.

6. The method of claim 4, wherein the wire is a guidewire inserted in a guidewire lumen of the catheter.

7. The method of claim 4, wherein the lumen is positioned generally in the center of the balloon when the balloon is in the collapsed position with the stent mounted thereon.

8. The method of claim 1, wherein the coating substance includes a polymer and/or a drug.

9. The method of claim 1, wherein the application of the coating is limited to an abluminal surface of the stent and optionally sidewalls of a frame structure of the stent.

10. The method of claim 1, additionally comprising (a) either (i) applying a potential to the stent, the potential having an opposite polarity as the polarity of the charged particles or (ii) grounding the stent; and/or (b) applying a potential to a wire disposed in a lumen of the catheter, the potential having the same polarity -as the charged particles.

11. The method of claim 10, wherein if the stent is grounded, the method additionally comprises during the application of the coating substance, initiate applying a potential to the stent, the potential being opposite in polarity that the charged particles.

12. The method of claim 1, wherein applying includes a process of electrostatic spray deposition.

13. A method of manufacturing an electrostatically-coated stent-balloon assembly, comprising:
positioning a stent on the balloon of a catheter assembly;
after the positioning, crimping the stent on the balloon, forming a stent-balloon assembly;
applying a potential to a guidewire located within a lumen of the stent-balloon assembly;
grounding or applying a potential to the stent wherein the potential is the opposite as that of the guidewire; and
depositing an electrostatically charged coating to the stent wherein the potential is the same as that of the guidewire. .

14. The method of claim 13, wherein the stent is grounded, and the guidewire and the electrostatically charged coating are positively charged.

15. The method of claim 13, wherein the stent is negatively charged, and the guidewire and the electrostatically charged coating are positively charged.

16. The method of claim 13, wherein the balloon is completely or substantially free from the electrostatically charged coating after the depositing.

17. The method of claim 13, wherein the crimping is performed by a method selected from one of roll crimping, collet crimping and iris crimping.

18. A method for electrostatically coating an abluminal surface of a stent, comprising:
positioning a stent on a balloon of a catheter system;
after the positioning, crimping the stent on the balloon;
applying a potential to a wire such that the balloon realizes the potential;
grounding or applying a potential to the stent wherein the potential is the opposite as that of the wire; and
depositing an electrostatically charged coating to the stent wherein the potential is the same as that of the wire.

19. The method of claim 18, wherein the stent is grounded, and the wire and the electrostatically charged coating are positively charged.

20. The method of claim 18, wherein the stent is negatively charged, and the wire and the electrostatically charged coating are positively charged.

21. The method of claim 18, wherein a surface of the balloon is free or substantially free from the electrostatically charged coating.

22. The method of claim 18, wherein the crimping is performed by a method selected from one of roll crimping, collet crimping and iris crimping.
